(19) United States
(12) Patent Application Publication
(10) Pub. No.: US 2016/0314296 A1
(43) Pub. Date: Oct. 27, 2016

(54) Method and System for Dynamic Runtime Selection and Modification of Conditional Expressions in Computations

(71) Applicant: SEQUITUR LABS, INC., Issaquah, WA (US)

(72) Inventors: Philip ATTFIELD, Fall City, WA (US); Paul CHENARD, Corvallis, OR (US); Simon CURRY, Chelmsford, MA (US)

(73) Assignee: Sequitur Labs ,Inc.

(21) Appl. No.: 15/103,741

(22) PCT Filed: Dec. 17, 2014
(86) PCT No.: PCT/US2014/070897

§ 371 Date: Jun. 10, 2016

Related U.S. Application Data
(60) Provisional application No. 61/917,290, filed on Dec. 17, 2013.

(51) Int. Cl. G06F 21/53

(52) U.S. Cl. CPC G06F 21/53; G06F 2221/033

(57) ABSTRACT

Runtime selection and modification of conditional expressions in a computing system has broad applicability in application areas involving deployments of large numbers of network-connected handsets and other devices, as well as in high availability computing environments and essential computing services. The invention describes the deferred evaluation of conditional statements in a trusted execution context such that the problem of spoofing return code is eliminated. The system allows for any set of relevant attributes to be considered in the conditional evaluation. The executable statements associated with the returned evaluation of the conditional is also dynamic and is selected at runtime.

### PRIORITY CLAIM

This application claims priority to U.S. Provisional Patent Application No. 61/917,290, Method and System for Dynamic Runtime Selection and Modification of Conditional Expressions in Computations, filed on Dec. 17, 2013.

### COPYRIGHT STATEMENT

All material in this document, including the figures, is subject to copyright protections under the laws of the United States and other countries. The owner has no objection to the reproduction of this document or its disclosure as it appears in official governmental records. All other rights are reserved.

### TECHNICAL HELD

Related technical fields are: Telecommunications, Digital Communication, Computer Security, Computer Technology, IT Methods for Management, Mobile Computing.

### BACKGROUND OF THE INVENTION

Conventional computer languages, whether compiled or interpreted, typically incorporate static conditional expressions. In utilization of these expressions, whether as interpreted source code or in compiled form such as compiled binary code, instances of these expressions cannot be changed in regard to either the structure or the content of the expressions used. For example, a conditional expression may have the form
if (conditional_expression)
{do actions . . . }

Here, “conditional_expression” is typically an expression such as “if x>y” to be evaluated using criteria and data that are visible to the application and accessible in the current function or procedure by some means. The application must be recompiled or reinterpreted to effect a change to the conditional expression. Here, the conditional expression may have a single possible result such as the above “if” example, or may have multiple possible outcomes (branches) with the selected branch depending on input values to the conditional expression, such as for a “switch” statement¹ as seen in C++, java and many other computing languages. Such conditional expressions may also be nested¹.

In a secure computing environment, the static nature of conditional statements may actually be the cause of security problems because it is insufficient to enforce security policies. The simplistic method of checking function return code values (which results in some sort of branch execution at the machine level), in the absence of an enforcement mechanism elsewhere, can be fairly easily bypassed by spoofing the return value with forged values or jumping to (or past) the appropriate branch instruction target. A conditional mechanism that does not suffer from these problems is needed.

As a simples example, consider the following conditional expression:
if A->X
else->Y

Meaning, if A is true, execute instructions at location X, else (if A is not true), then execute instructions at location Y. If this is statically compiled code, the location of X can be spoofed to point to Z where malicious or unintended instructions reside. The purpose of this invention is to eliminate vulnerabilities associated with this artifact of statically compiled or interpreted conditional expressions.

Beyond the security advantages, the capability to write conditional code without the programmer having to know exactly what the condition is or what the resulting action might be at programming time, is very powerful. The deferral of conditional evaluation possibly to a remote system (referred to here as a “proxy decision evaluation”) and the return of a dynamic “handle” that allows the condition to change as needed has clear advantages over a statically compiled conditional statement. The present invention enables this capability.

### BRIEF DESCRIPTION OF THE DRAWINGS

FIG. 1. Schematic representation of a policy-based mechanism for securing computing devices where use of the invention is beneficial.

FIG. 2. Flowchart for a generic conditional statement execution with associated action. This use case example shows a policy based mechanism for securing computing devices where use of the invention is beneficial.

FIG. 3. Execution context within three different trust contexts for conditional evaluation according to one embodiment of the invention.

FIG. 4. Mandatory, remotely-managed conditional execution according to one embodiment of the invention.

### DETAILED DESCRIPTION OF THE INVENTION

We now present a new, dynamic form of conditional expression, in which the conditional expression itself can be modified dynamically at runtime, with modification such as selection of all or part of its constitutive elements and structure from some set of conditional expressions, based on evaluating some other conditional for performing the selection, and for which the structure of the expression, the comparison operators, and the data used in the expression can be changed.

As a first, non-limiting example, consider the following pseudo-code expression:
if (conditional (condition_42, serialize (“hair_color” hair_color, “shoe_size”, shoe_size)) {do actions . . . }

In the above example, condition_42 denotes a “conditional” expression and supplies hair_color and shoe_size as local variables, potentially along with other contextual requirements, to satisfy or otherwise make possible the evaluation of the expression that would cause condition_42 to be true or false, in the case of an “if” expression, or to make condition_42 possible to evaluate for the selection of one conditional expression from a set of multiple conditional expressions, in the case that condition_42 is a switch statement. In such a case of a switch statement, each candidate conditional could be presented from one output branch of condition_42 expressed as a switch statement, a “case” in specific example of the C++ language¹ and certain other common computing languages.

The new capability enabled by the invention is the ability to dynamically manage and change conditional expressions at runtime without having to recompile, rebuild, reinterpret, or otherwise change an application. The key inventive step is deferring the definition of the predicate of the expression to runtime thus allowing the enforcement of security policies or other remote operations prior to predicate execution. The security policy can be based on the outcome of the condition or any other pertinent variable or set of variables. Local variables might only be visible locally, and so may need to be provided directly to the conditional evaluator due to scope limitations. Other elements of the expression can be sourced from elsewhere. For example, an online directory or database, personal profile, or tracking data held locally or remotely via a network, could be the source of contextual data that is required to evaluate condition_42.

Notably not only the supplied values, but also the variable type, number of elements, and other aspects of form of the supplied contextual data, may be used within condition_42 for selection of the appropriate conditional expression. This is somewhat akin to polymorphism via function overloading in C++.

Among the most important aspects of the invention is the partitioning of execution contexts, essentially establishing protective barriers between execution of both the evaluation of the conditional itself, as well as execution paths depending on the result of said evaluation.

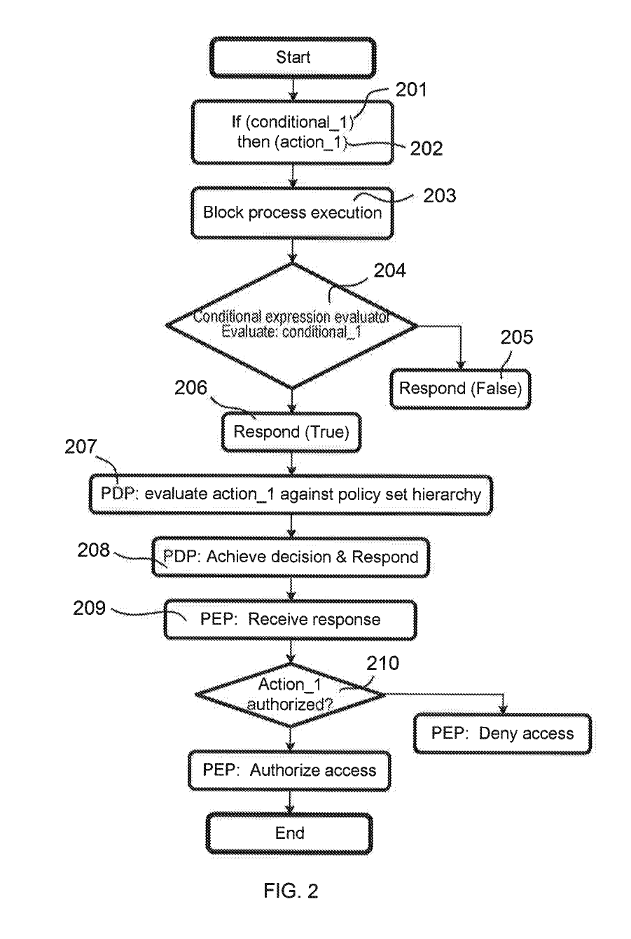

FIG. 2 illustrates a high level flow diagram of how the invention functions. The conditional (conditional_1) 201 must be evaluated. Then, if it returns “true”, then the action (action_1) 202 will be executed. The process of the application is blocked 203 so that the evaluation of the conditional can be performed separately in a privileged context 204. If it returns “false” 205, then the application is unblocked and action_1 is not executed. However, if it returns “true” 206 then the PDP must determine if action_1 may be executed in this context according to current policy 207. The PDP determines if action_1 can execute 208 and informs the PEP that controls the assets needed 209. The PEP then authorizes or denies access to the asset 210 (the camera, for example) and action_1 executes by the application which is now unblocked.

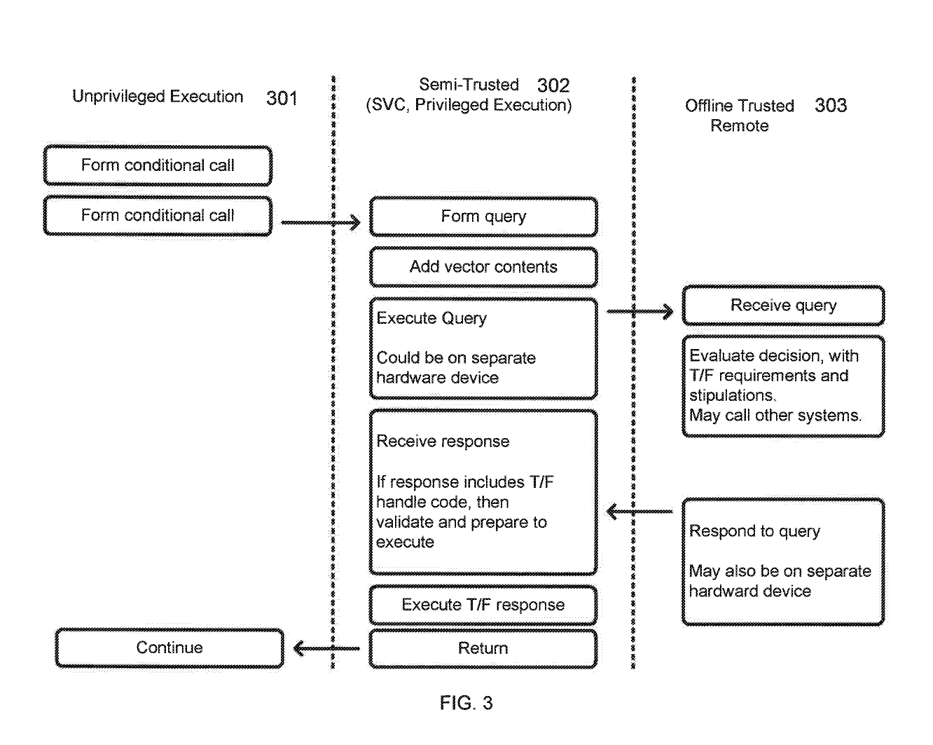

FIG. 3 shows the flow of control to evaluate and execute a conditional statement that transitions from an unprivileged context 301 (where the application executes) through a semi-trusted context 302 where the query and vector are formed, to the trusted context 303 where the evaluation actually takes place. The response then flows back through the semi-trusted context and finally back to the application.

For example, consider one embodiment, in which a calling application evaluates a conditional that (in the simplest case) results in a value of either “true” or “false”. A “true_handle” and “false_handle” correspond to actions to be taken if the conditional evaluates to true or false, respectively.

From the unprivileged context, this may look like the following pseudo-code:
conditional (condition_name, true_handle, false_handle, local_arguments)

This would result in the following steps being performed in a protected context (outside of the visibility of the unprivileged application):
Step 1. Formulate call (create “vector”)
Step 2. Add other “vector entries”—that are not visible/accessible to the unprivileged application
Step 3. Execute call to condition& expression evaluator
Step 4. Examine result with stipulations
Step 5. Execute code that corresponds to resulting decision branch (T/F)

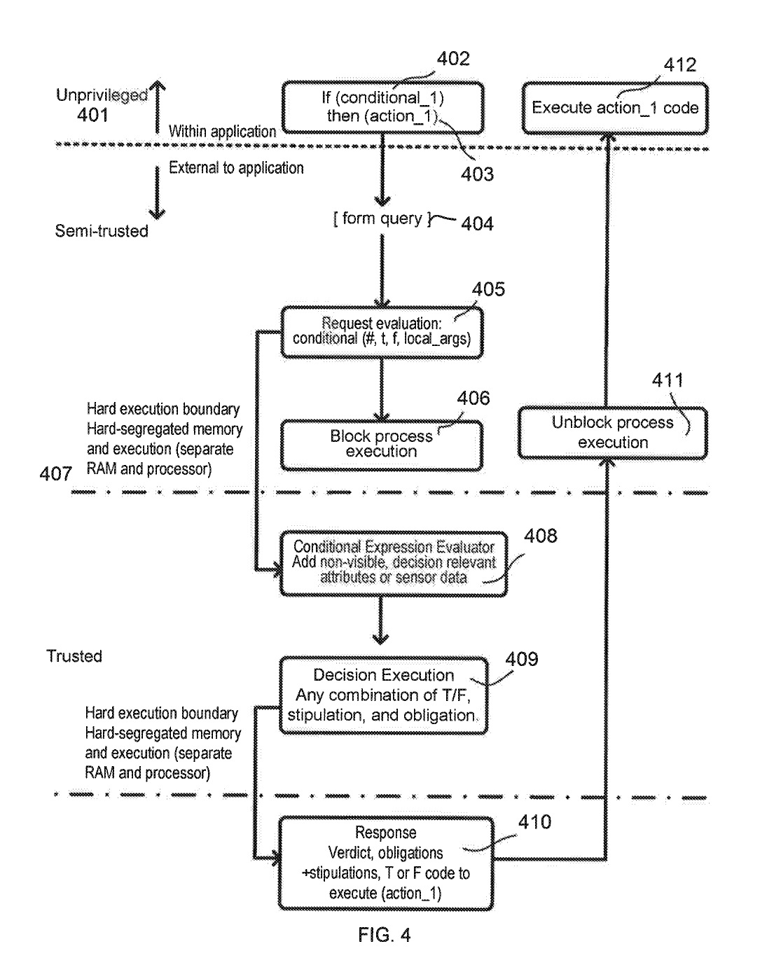

A specific condition may be modeled such that “true_handle” and “false_reference” already on-device protected calls, or—via stipulation—supplied code that implements true_handle and/or false_handle, which is pushed to the computing device with the resulting decision. The duration of the validity of the decision or accompanying code is subject to stipulation. See FIGS. 3 and 4. Note that a stipulation may comprise some form of attestation (see, e.g., U.S. application Ser. No. 14/080,660).

FIG. 4 is a more detailed view of this process. The application runs in a unprivileged context 401. It wants to evaluate a conditional (conditional_1) 402 and if it returns “true” then it will execute action_1 403. However, at this point in execution, the application does not know what action_1 is or what code to execute to perform it.

The next step transitions to the semi-trusted context where the query is formed to 404 evaluate the conditional statement. It requests evaluation 405 and blocks the application process from continuing any further 406. This is a mandatory block that cannot be interrupted by the application. It must wait for a return response from the conditional evaluation.

A hard boundary is crossed here 407 because this is the trusted context where the conditional evaluation will take place. Any non-visible relevant attributes needed to determine the conditional statement are added to the vector here 408. These could include security policy information, execution context data, or any other information necessary to evaluate the conditional statement. The conditional is then evaluated 409. The result is a verdict (T/F) but also any obligation or stipulations that are associated with the verdict. The code to be executed as action_1 is now known and is part of the return vector 410.

Finally, the application process is unblocked 411. If the conditional evaluated to “true”, then the code returned with the vector is executed as action_1. If it returned “false”, then the application skips to its next instruction and proceeds 412.

Regarding evaluation of conditionals, and particularly with regard to scalability and performance considerations, we note that multiple conditional transactions and evaluations could be performed simultaneously or near-simultaneously, such as in a concurrent environment with multiple executing unprivileged threads. These threads could perform conditionals during their respective slices.

Also note that embodiments can have more than one execution context. FIG. 3 depicts one embodiment in which there are three: unprivileged, semi-privileged, and privileged. The invention contemplates as many execution contexts as appropriate for the desired application. The invention also contemplates more than merely true/false execution conditionals. For example, one embodiment allows for execution of one branch upon successful completion of the target conditional, and another upon exception (or several depending on the nature of the exception). Other embodiments examine “return values” of conditional code and execute branches depending on the value (see the discussion of the “switch” statement above as one example).

The “proxy decision evaluator” embodiment might be implemented without any additional infrastructure by using a remote process to evaluate a conditional (any form of remote procedure call would suffice) that returns a handle to executable code.
if (condition_allow (arg1, arg2))
then (action_1_handle(return_args));

In this example, condition_allow is executed remotely and can be specified at any time up to when it is called. It executes and returns a handle to executable code to fulfill the obligation associated with condition_allow. The return handle action_1_handle may also be specified at any time up to when it is called. This is a simplified version of the invention with essentially no intermediate infrastructure.

Example embodiments of partition boundaries for execution contexts could be via ioctl ( ), syscall ( ), or SMC (if, for example, in SVC (supervisor/privileged) mode). Implementation of conditional evaluation and management could also be in a suitably isolated execution environment such as a bus-connected (hardware) coprocessor, shared-RAM coprocessor, or suitably protected/isolated MMU (e.g., area of RAM with execution separation provided and enforced by the OS thread/scheduling mechanisms.

As non-exhaustive examples, other embodiments could include providing a protected execution context on a computing device entirely separate from that executing the unprivileged application.

Where execution contexts are partitioned across processor (or even machine) boundaries, a suitable mechanism to ensure trust between peers needs to be in place. Embodiments include use of shared secrets (e.g., H-MAC), asymmetric cryptography (e.g., X.509), or any other known trust mechanism or equivalent. Alternative embodiments will immediately become apparent to those of ordinary skill in the art.

While the invention is not intrinsically limited to a specific semantic form, we suggest the following two potential ways to present our conditional expression to a compiler or interpreter:

1. the dynamic conditional expression can be named explicitly in a way that is distinct from a conventional expression, for example through the use of unique condition names such as “if_d” or “switch_d” in place of “if” “switch” expressions or

2. the dynamic conditional expression can a additional labelling or tagging such as prefacing or trailing tags, for example, “dynamic_conditional” or “deferred_predicate”.

Central to the invention are conditionals that are evaluated and acted upon at a low level in response to higher level calls. In one embodiment, aspects of the invention are somewhat analogous to an exception mechanism (see, e.g., Hennessy, J. and Patterson, D. (2011). Computer Architecture: A Quantitative Approach. 5^{th} Ed. Morgan Kaufmann.). In computing environments where the invention is used, a function call that attempts to access a conditional is restricted to executing a next CPU instruction that is controlled by the invention. This prevents potential exploits such as buffer overruns and under-runs. By comparison, conventional function calls might otherwise result in return of a branch instruction, potentially with an exploitable address. Therefore, rather than intercept a function call by returning a branch instruction, the enforcement mechanism directly modifies the CPUs program counter (or an equivalent register) to insert a next instruction giving an action consistent with the policy decision. To further enhance security, the inserted post-call code is located in memory at a non-contiguous address to the resource-requesting calling code (analogous to pre-exception code, in the case of an exception handler), and that memory location is generally unknown to the calling code to further reduce the possibility of exploits from attacks on any memory address. One may also further strengthen the enforcement mechanism from attack by not having the inserted next instruction present in accessible memory until the lower level has completed evaluating the conditional, so that the instruction cannot be subject to earlier attack. This can be accomplished, for example, by holding instruction(s) for the enforcement mechanism in an area of protected memory, and by encrypting the instruction(s) to prevent attack.

If an exception mechanism (e.g., an illegal instruction, or—in the case of ARM family microprocessors and certain other processors—a Secure Monitor Call (SMC), or similar trap, etc.) is employed as the enforcement mechanism, then the caller process is suspended during execution within the illegal instruction handler or trap. Further, the next instruction to be executed by the caller is subject to the value of the return program counter (PC) that is put in place prior to return from the exception. This means that a return execution address does not have to be collocated with the original trap call nor does it have to contain a branch that corresponds to an allow or deny result. Further to this, the memory containing the subsequent code to execute can be allocated at runtime and subsequently released once it has been executed. This hinders the ability to locate the resource and/or bypass the enforcement and access mechanism. One potential way to avoid this is to have a certain number of instructions post-call decrement an atomic so that the next pass of a work queue can allow freeing/removal of the dynamically allocated code chunk.

A pseudo-code representation of this might be:

```
void access_resource (...) {
    Preserve the link register (LR) pointing to the
            return address, and the stack context so
            that frame can be popped-this function
            does not “return” in normal sense;
    Gather context;
    Form parameters/vector prior to trap;
    Illegal instruction or trap
}
```

At the point of trap execution, the PC points to the illegal instruction. Upon return from the trap, the PC will execute the sequence of instructions that allow the attempted operation to proceed (in the ease of allowed operation) or fail (in case of denial). The subsequent operation of either the allow or the deny code chunk should either return to the caller (along with whatever is necessary to release stack resources and this code segment) or cause the calling activity to fail. The latter is potentially equivalent to sys_exit if this is a killable process.

Other mechanisms that can be used in conjunction with the above technique are:
Possible use of physical memory; the memory management unit (MMU) is turned off during execution of the code that is returned to the caller. The MMU is then re-enabled at end of execution.
If the MMU has suitably advanced capabilities then hardware protection can be employed such that code is executable but not readable.

The invention may not be intrinsically limited to one specific implementation, potential implementations include the use of Remote Procedure Calls (RPCs) or Remote Function Calls (RFCs).

In certain network-based applications of our invention, the set of conditional expressions available for selection, as well as the required contextual data, may be remote from the computational entity performing the selection, and accessible over a network such as the internet, or some other wide area network (WAN) or over a local area network. Virtual private networks (VPNs) may also be utilized for communication of expression and contextual data, for security and other reasons.

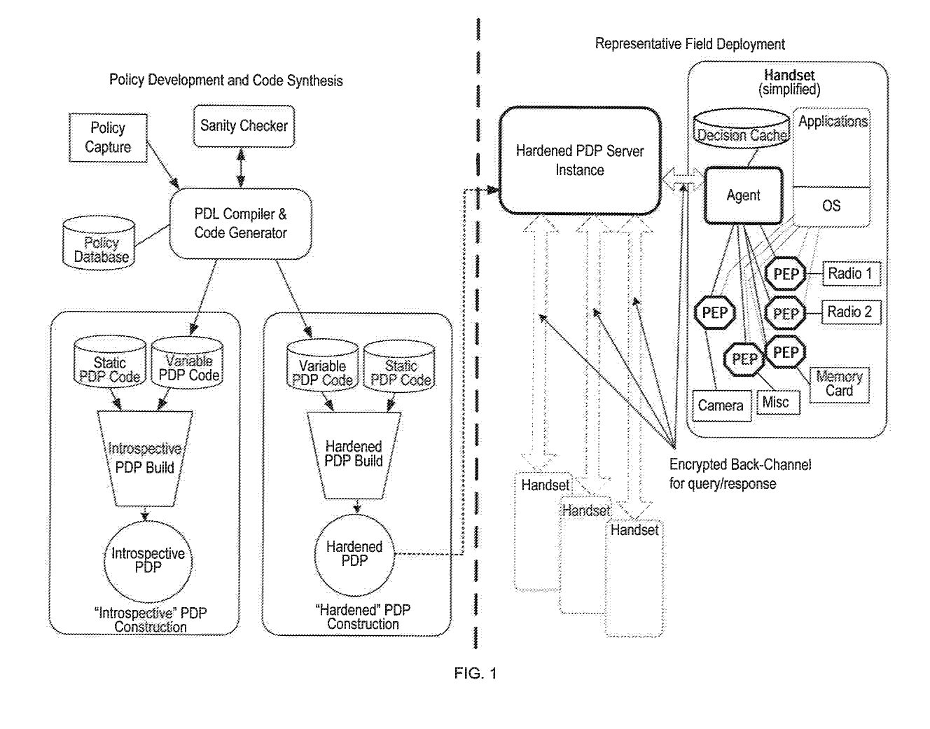

There are a wide variety of ways in which our invention can be deployed in a networked environment. FIG. 1 is representative of one such deployment. In regard to FIG. 1, the scenario presented shows management of conditionals being performed locally on a mobile device, but we further note that this can performed on other computing resources in the system, provided that access to required data items is available to such resources. The conditional management and access to conditionals may be accomplished, for example, through the use of dynamically loaded code such as .so (shared object) files in the Unix operating system, or dynamically loaded libraries (DLLs) in the Windows operating system.

While we believe that there are many potential application areas for our invention, we specifically note the following promising application areas for our invention, while not restricting its applicability to these areas.

First, in U.S. patent application Ser. Nos. 13/945,677, 14/080,660, and 61/746,533, we described systems and methods for various aspects of securing computing devices such as mobile handsets. Among the embodiments described were those where flow of an executing software application was affected by environmental conditions outside the control of that application. For example, enforcement of decisions resulting from the handset results from queries to a Policy Decision Point (PDP) is performed at a Policy Enforcement Point (PEP) on the handset, in some cases at a lower level than the device operating system so as to eliminate certain vulnerabilities such as undesired root access and other exploits. The PEPs thereby serve to provide rigorous enforcement of access decisions, in some cases by appropriately controlling access to resources and information located on the handset or elsewhere such as in a remote location on a network, and by monitoring the execution of allowed actions. In some cases, such control will consist of appropriately allowing or denying access to a resource. In other cases, intermediate limits of usage of certain resources can be applied, such as bandwidth throttling (or other Quality of Service (QoS) limitations or priority levels) or other variable control of certain assets such as maximum picture capture resolution allowed from a camera, or maximum memory and CPU utilization allowed to an application. (See, e.g., FIGS. 4 and 5.)

It is desirable to have the control points corresponding to PEPs at as fundamental a level as possible on the computing device, in order to prevent all possible undesirable usage of the protected assets from everything from malicious applications operating at application level, to “root exploits” that may be able to get root-level access to the handset operating system, among many other threats in the mobile wireless environment. In one embodiment of the invention, a unique coupling is used between decision cache, PEP software, and enforcement mechanisms.

Ideally, only entry points such as driver stubs exist in untrusted areas of the OS. Sensitive resources should be referenced by handle only (e.g., certain types of files), with trusted operations taking place only within a trusted zone. Other sensitive data could be object metadata (data that classifies the nature of, e.g., an application or file, for policy purposes), a policy decision cache, plus policy/backchannel code. However, insertion and operation of such low-level PEPs can lead to unwanted performance degradation, and in some cases, to system instabilities. More generally, enforcement mechanisms are constructed that are not trivially bypassed.

Besides satisfying the above requirements, one advantage of using this invention in such a system is that new policies can be deployed across a large number of mobile devices without the need to compile and instantiate new versions of decision evaluation servers and client-side binaries. In this case, the client devices might be mobile “smartphone” handsets, but could be any network connected devices such as those within an “Internet of Things”². Related applications exist in home automation systems.

Second, using our invention for dynamically runtime selectable conditional statements in a distributed computing system such as one within the Hadoop large scale distributed computing framework³ could mean that runtime changes can be made to running instances of computing nodes participating in MapReduce-style computations large data sets, to modify the existing nodes suitably for new computational jobs, or to alter pending jobs, without instantiating new nodes. A related application would be in a system with a large number of autonomous agents, for which agent behaviour could be remotely modified during runtime using our invention.

Third, another potential application area is in pattern or structure recognition from computer-supported vision systems. In this case, the sensor hardware generates a vector of data, and the computing backend (a protected execution context) has ability to analyze the vector for properties. In such a case, our dynamic conditional selects a conditional expression for use in the data analysis appropriately based on the contextual data and form of the data vector.

We also consider non-security-related application domains for the invention. The purpose of the deferred conditional evaluation and dynamic return code handle can be for reasons other than security. For example, advertisement engines such as Google AdSense could be linked as a service to the present invention such that given the context of the conditional, a specific ad is selected and presented to the calling application. Similarly, navigation services for mobile applications might use the location of the device that is calling for the conditional evaluation as part of the context that influences what code is executed as the result of the conditional evaluation.

Finally, we note that our invention's capability for runtime modification of conditional expressions, without the need to interrupt the running of an existing system, has important applicability in other areas where high availability and/or continuous system operation are of high importance. Such application areas include critical life support and maintenance systems, adaptive control systems, remote, adaptive learning systems such as semi-autonomous vehicles, and also automated systems for hazardous environments or hazardous waste processing systems.

### REFERENCES

1. See e.g. H. Schildt, C++—The Complete Reference, 2nd edition, pp. 67-70 McGraw Hill, 1995, ISBN 0-07-882123-1
2. K. Ashton, “That ‘Internet of Things’ Thing, RFJD Journal Jun. 22, 2009 (available online as of Oct. 20, 2013 at http://www.rfidjournal.com/articles/view?4986)
3. T. White, Hadoop—The Definitive Guide, O'Reilly, 2009, ISBN 978-0-596-52197-4

What is claimed is:

1. A system for evaluating a dynamic conditional statement at runtime in a privileged execution context comprising:
a first processor that executes unprivileged machine instructions;
a memory;
means for preventing unprivileged machine instructions executed on the first processor from reading or modifying the memory; and
means for coupling the first processor to a second processor where the first processor invokes an evaluation of a dynamic conditional whereby the evaluation of the dynamic conditional is performed by the second processor.

2. The system of claim 1, wherein the means for coupling the first processor to the second processor enables the first processor to execute specific machine instructions as determined by a returned result of the evaluation of the dynamic conditional statement by the second processor.

3. The system of claim 1, wherein the means for coupling the first processor to the second processor enables the first processor to reference data accessed by the second processor during the evaluation of the dynamic conditional statement.

4. The system of claim 1, wherein the means for coupling the first processor to the second processor comprises a hardware bus.

5. The system of claim 1, wherein means for coupling the first processor to the second processor comprises a computer network.

6. The system of claim 1, wherein
the first processor and the second processor are the same processor;
the memory comprises a protected memory; and
the means for preventing unprivileged machine instructions from reading or modifying the memory is the protected memory.

7. The system of claim 1, wherein a second dynamic conditional statement is evaluated concurrently with the first dynamic conditional statement.

8. A method for evaluating a dynamic conditional statement at runtime in a privileged execution context comprising the steps:
executing unprivileged machine instructions to identify the dynamic conditional to be evaluated;
preventing the unprivileged machine instructions reading or modifying data in a memory; and
evaluating the dynamic conditional in a privileged execution context, where privileged machine instructions are allowed to read or modify data in the memory.

9. The method of claim 8, comprising the following steps:
returning specific unprivileged machine instructions that result from the evaluation of the dynamic conditional statement by the privileged machine instructions; and
executing the specific unprivileged machine instructions, where the additional unprivileged machine instructions are prevented from reading or modifying data in the memory.

10. A method for selecting, modifying, and managing dynamic conditional statements during runtime in a computational environment comprising the steps:
adding the vector contents that include a true handle, a false handle and any required local arguments;
evaluating the condition;
determining stipulations associated with the verdict;
selecting the handle to the response machine instructions; and
returning the response handle to the application for execution.

11. The method of claim 10, wherein a governing conditional statement is used by the conditional expression evaluator to select the dynamic conditional statement from a set of conditional statements, for insertion into the computing environment.

12. The method of claim 10, wherein source code is interpreted dynamically during execution.

13. The method of claim 10, wherein executable code is compiled from source code into binary form prior to execution such that the application can execute the instructions.

14. The method of claim 10, wherein source code is compiled into a machine neutral intermediate form prior to execution.

15. The method of claim 10, wherein specific computational tasks are performed on a network-connected device or on a remote computing resource.

16. The method of claim 10 comprising controlling or managing functional capabilities of at least one computing device.

17. The method of claim 10 comprising controlling or managing local or network file access of at least one computing device.

18. The method of claim 10 comprising evaluating the dynamic conditional statement within a distributed computing framework.

19. The method of claim 10, wherein the distributed computing framework comprises distributed processing and distributed storage.

20. The method of claim 10, wherein evaluating the dynamic conditional statement returns a conditionally relevant advertisement link to the application.

21. The method of claim 10, wherein evaluating the dynamic conditional statement comprises analyzing geo-location information from the mobile device as context for the condition.

22. The method of claim 10, wherein evaluating the dynamic conditional statement comprises analyzing an input digital signal.

23. The method of claim 22, wherein analyzing an input digital signal comprises:
detecting the presence or absence of representation of a physical object in the digital signal;
detecting representation of motion of a physical object in the digital signal; or recognizing a pattern in the digital signal.

24. A system that evaluates a dynamic conditional statement at runtime comprising:
a processor that executes instructions for the host application;
a system that remotely executes code on another processor; and
a second processor that executes the conditional evaluation and selects the handle to the resulting code that the first processor executes depending on the result of the conditional evaluation;

25. The system of claim 24 wherein the first and second processors are the same processor.

26. A method for evaluating a dynamic conditional statement at runtime comprising the steps:
calling for the remote execution of code by the host application to evaluate a conditional statement that may include argument variables;
evaluating the conditional statement by the remote process that may include additional data or variables;
returning a verdict of the conditional evaluation from the remote process that includes a handle to executable code associated with that verdict.
